(19) United States
(12) Patent Application Publication
(10) Pub. No.: US 2016/0017839 A1
(43) Pub. Date: Jan. 21, 2016

(54) Piston Engine with Non-Circular Combustion Chamber

(71) Applicant: AVL Powertrain Engineering, Inc., Plymouth, MI (US)

(72) Inventor: Gustav R. JOHNSON, Canton, MI (US)

(21) Appl. No.: 14/804,571

(22) Filed: Jul. 21, 2015

Related U.S. Application Data
(60) Provisional application No. 62/026,757, filed on Jul. 21, 2014.

(51) Int. Cl. F02F 1/18; F02F 3/00

(52) U.S. Cl. CPC F02F 1/183; F02F 3/0015

(57) ABSTRACT

A design for a piston engine, cylinder block, and piston is provided. The cylinder block includes a cylinder wall defining at least one cylinder bore for receiving the piston disposed therein. A combustion chamber disposed within the cylinder bore is defined by the piston and the cylinder wall. The combustion chamber has a non-circular cross-section and the cylinder wall includes a first pair of opposing faces and a second pair of opposing faces that converge at rounded intersections. A pair of opposing fuel injectors extend through the cylinder block to the cylinder bore. The pair of opposing fuel injectors are positioned along the second pair of opposing faces of the cylinder wall such that the pair of opposing fuel injectors spray converging fuel plumes into the combustion chamber to reduce air/fuel stratification across the non-circular cross-section of the combustion chamber.

### CROSS-REFERENCE TO RELATED APPLICATIONS

This application claims the benefit of U.S. Provisional Application No. 62/026,757, filed on Jul. 21, 2014. The entire disclosure of the above application is incorporated herein by reference.

### FIELD

The present disclosure relates to generally to the field of piston engines. More particularly, a piston engine with a non-circular combustion chamber, and components thereof, are disclosed.

### BACKGROUND

Piston engines represent one of the most common forms of the internal combustion engine. Such engines burn fuel to produce power. Many piston engines burn gasoline or diesel fuels, although other fuels may be used. Generally, piston engines have a cylinder block. The cylinder block includes a cylinder wall defining one or more cylinder bores that extend longitudinally through the cylinder block. A piston is slidingly disposed in each of the cylinder bores. During operation of the piston engine, the pistons reciprocate within the cylinder bores of the cylinder block in response to combustion of the fuel. Although other configurations are possible, a cylinder head may be disposed in sealing engagement with the cylinder block. Together, the cylinder head, the cylinder wall, and the pistons define a combustion chamber within each of the cylinder bores. Where the piston engine is a spark-ignition engine (e.g., a gasoline engine), a spark plug extends through the cylinder head and into each of the combustion chambers. The spark plug selectively applies an electrical spark to each of the combustion chambers to ignite an air/fuel mixture contained therein. Where the piston engine is a compression ignition engine (e.g., a diesel engine), a glow plug may or may not be provided in the cylinder head to aid in starting of the compression ignition engine.

Conventional piston engines further include a crankcase disposed in sealing engagement with the cylinder block. The crankcase abuts the cylinder opposite the cylinder head and defines a crankcase cavity therein. A crankshaft is rotatably supported in the crankcase cavity. The crankshaft extends laterally with respect to the cylinder bores and rotates in response to operation of the engine. Accordingly, the crankshaft outputs the rotational power of the piston engine. Connecting rods extend between the pistons and the crankshaft. Each connecting rod is rotatably connected to one of the pistons and the crankshaft such that the connecting rod translates reciprocal motion of the piston to rotational motion of the crankshaft.

Conventional piston engines have cylinder bores and pistons with circular cross-sections. Accordingly, the combustion chambers defined within these piston engines are also circular in cross-section and generally form a cylindrical volume. Traditionally with carbureted and manifold fuel-injected piston engines, each piston draws a pre-mixed air/fuel mixture into the combustion chamber during the intake stroke (where the piston is moving longitudinally toward the crankshaft). As such, the air/fuel mixture is fairly uniform (well mixed) by the time it enters the combustion chamber. In more recent years, direct fuel injection has seen increasing popularity due to its attendant fuel economy and emission benefits. In direct fuel-injected piston engines, the fuel is sprayed directly into each of the combustion chambers by a fuel injector. Accordingly, the air/fuel mixture is mixed inside the combustion chamber after the air is drawn into the combustion chamber by the piston. This leaves very little time for mixing of the air/fuel mixture before ignition. The air/fuel mixture is thus more stratified in the combustion chamber. Furthermore, the fuel plume that the fuel injector sprays into the combustion chamber tends to accumulate in the far side of the cylindrical volume of the combustion chamber away from the fuel injector. As a result, incomplete combustion and non-uniform combustion fronts tend to occur in direct injected piston engines.

### SUMMARY

The subject disclosure provides a piston engine apparatus that addresses the air/fuel stratification problem noted above and that has improved overall packaging geometry in comparison to conventional piston engines.

In accordance with one aspect of the subject disclosure, the piston engine includes a cylinder block, a piston, and a combustion chamber. The cylinder wall has at least one cylinder bore that defines a cylinder bore axis. The piston is slidingly disposed in the at least one cylinder bore such that the piston reciprocates within the at least one cylinder bore along the cylinder bore axis during operation of the piston engine. The combustion chamber is disposed within the at least one cylinder bore on one side of the piston. In other words, the piston divides the at least one cylinder bore into two volumes, one of which is the combustion chamber. As such, the combustion chamber is bounded by the piston and the cylinder wall. The at least one cylinder bore, piston, and combustion chamber each have a non-circular cross-section that is transverse to the cylinder bore axis. Further, the cylinder wall has a plurality of faces that slidingly engage the piston thus forming the combustion chamber between the piston, the cylinder head, and the plurality of faces of the cylinder wall. The plurality of faces of the cylinder wall includes a first pair of faces and a second pair of faces. The first pair of faces oppose one another such that the combustion chamber is disposed between the first pair of faces. The second pair of faces also oppose one another and extend between the first pair of faces. The first pair of faces and the second pair of faces of the cylinder block converge at rounded intersections. The rounded intersections have a different curvature relative to the first pair of faces and the second pair of faces. Advantageously, the non-circular cross-section of the at least one cylinder bore, piston, and combustion chamber is a more efficient use of cylinder block volume in comparison to other cross-sectional shapes, such as the circular cross-section of cylindrical cylinder bores. This allows the cylinder block to be made smaller for any given displacement of the piston engine while the rounded intersections provide improved sealing, wear resistance, and combustion characteristics over sharp (i.e. angular) intersections.

In accordance with another aspect of the subject disclosure, the first pair of faces of the cylinder block extend along a first length and the second pair of faces of the cylinder block extend along a second length that is smaller than the first length. Accordingly, the non-circular cross-section of the at least one cylinder bore, piston, and combustion chamber is elongated along the first pair of faces relative to the second pair of faces. In accordance with another aspect of the subject disclosure, the piston includes a crown portion and a skirt portion. The skirt portion extends longitudinally from the crown portion. The crown portion has a periphery that includes a first pair of side and a second pair of sides. The first pair of sides extend between the second pair of sides such that the first pair of side and the second pair of sides meet at rounded corners. The rounded corners have a different curvature relative to the first pair of sides and the second pair of sides.

In accordance with another aspect of the disclosure, the piston engine may include a pair of opposing fuel injectors that are disposed in fluid communication with the combustion chamber. Each fuel injector of the pair of opposing fuel injectors extends through the cylinder block to the at least one cylinder bore. The non-circular cross-section of the at least one cylinder bore, piston, and combustion chamber may be elongated where the non-circular cross-section is bisected by a first centerline having a first distance and a second centerline having a second distance that is smaller than the first distance. The pair of opposing fuel injectors are positioned along the first centerline on opposite sides of the at least one cylinder. Accordingly, the pair of opposing fuel injectors spray converging fuel plumes into the combustion chamber during operation of the piston engine to reduce stratification of the air/fuel mixture across the non-circular, elongated cross-section of the combustion chamber. Advantageously, the non-circular, elongated cross-section of the combustion chamber matches the fuel plume geometry of the fuel sprayed into the combustion chamber by the pair of opposing fuel injectors. Accordingly, the fuel is more evenly sprayed across the combustion chamber and areas receiving too little fuel or too much fuel are reduced. Combustion efficiency is thus improved with less incomplete combustion leading to greater fuel economy and reduced emissions.

In accordance with yet another aspect of the subject disclosure, the cylinder block may define multiple cylinder bores. For example, the cylinder block may define a first cylinder bore and a second cylinder bore each having a first pair of faces and a second pair of faces. The first cylinder bore and the second cylinder bore may be arranged in a side-by-side spaced relationship such that one of the first pair of faces of the first cylinder bore is immediately adjacent one of the first pair of faces of the second cylinder bore. Advantageously, this cylinder arrangement improves the overall packaging geometry of the piston engine. Engine parameters and material limitations dictate the minimum block thickness between adjacent cylinder bores. For a piston engine of any given number of cylinders and displacement, this minimum block thickness between adjacent cylinders dictates the overall length of the cylinder block. In accordance with the cylinder arrangement of the subject disclosure, the overall length of the cylinder block can be reduced while maintaining the minimum block thickness between adjacent cylinders because the width of each cylinder is less for the given displacement. This reduces the overall dimensions of the piston engine and can lead to weight and cost savings because less material is required for the cylinder block.

### BRIEF DESCRIPTION OF THE DRAWINGS

Other advantages of the present invention will be readily appreciated, as the same becomes better understood by reference to the following detailed description when considered in connection with the accompanying drawings wherein:

FIG. 1 is a front cross-sectional view of an exemplary piston engine constructed in accordance with the subject disclosure where the piston engine is a direct fuel-injected two-stroke engine;

FIG. 2 is a front cross-sectional view of an exemplary piston engine constructed in accordance with the subject disclosure where the piston engine is a direct fuel-injected four-stroke engine;

FIG. 3A is a top cross-sectional view of the piston engine shown in FIGS. 1 and 2 showing an exemplary cross-section of the at least one cylinder bore;

FIG. 3B is another top cross-sectional view of the piston engine shown in FIGS. 1 and 2 showing another exemplary cross-section of the at least one cylinder bore;

FIG. 3C is another top cross-sectional view of the piston engine shown in FIGS. 1 and 2 showing another exemplary cross-section of the at least one cylinder bore;

FIG. 3D is another top cross-sectional view of the piston engine shown in FIGS. 1 and 2 showing another exemplary cross-section of the at least one cylinder bore;

FIG. 4 is a perspective view of an exemplary piston constructed in accordance with the subject disclosure;

FIG. 5 is a side cross-sectional view of another exemplary piston engine constructed in accordance with the subject disclosure where the piston engine includes multiple cylinder bores;

FIG. 6 is a top cross-sectional view of the piston engine shown in FIG. 5;

FIG. 7 is a front cross-sectional view of an exemplary opposed-piston engine constructed in accordance with the subject disclosure where the piston and the opposing piston are moving toward one another; and

FIG. 8 is another front cross-sectional view of the exemplary opposed-piston engine shown in FIG. 7 where the piston and the opposing piston are moving away from one another.

### DETAILED DESCRIPTION

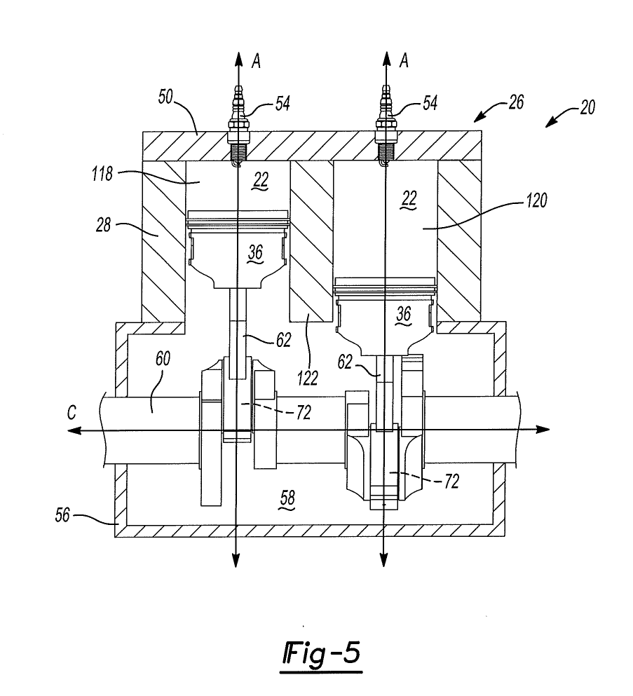

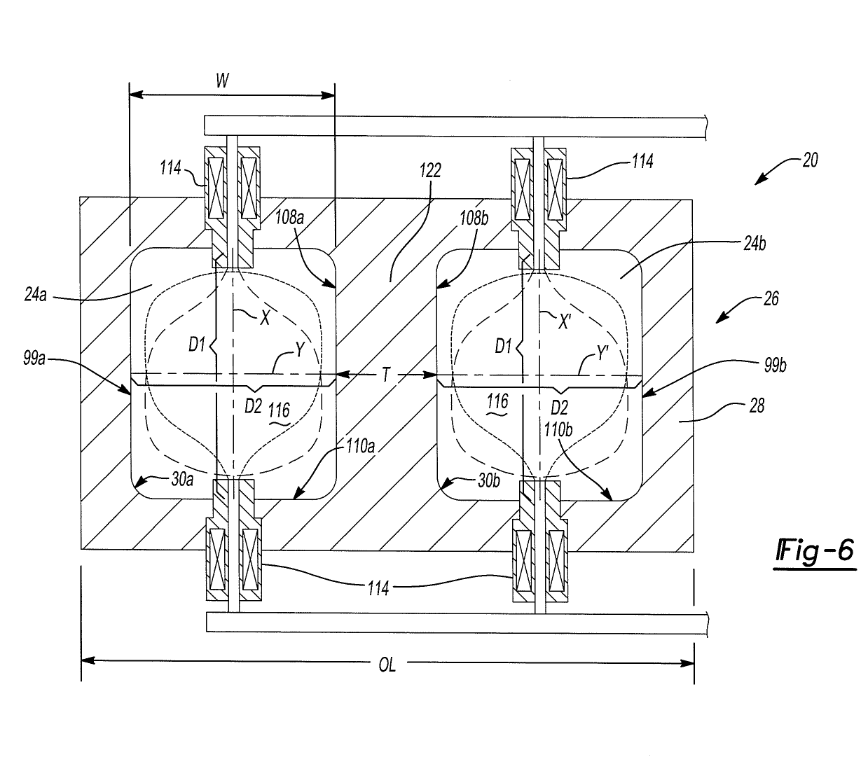

Referring to the Figures, wherein like numerals indicate corresponding parts throughout the several views, a piston engine 20 having non-circular combustion chambers 22 is disclosed. It should be appreciated that the term “piston engine” as used throughout the present disclosure generally refers to any two-stroke or four-stroke engine. Such piston engines 20 may have one or more cylinder bores 24. Where the piston engine 20 has multiple cylinder bores 24, the cylinder bores 24 may be arranged in one or more cylinder banks 26 (FIGS. 5 and 6). By way of example and without limitation, the cylinder banks 26 may form a V-type cylinder arrangement, an in-line cylinder arrangement, or a horizontally opposed cylinder arrangement. It should further be appreciated that the piston engine 20 may be any spark-ignition engine (e.g., gasoline engine) or compression ignition engine (e.g., diesel engine).

Example embodiments will now be described more fully with reference to the accompanying drawings. Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

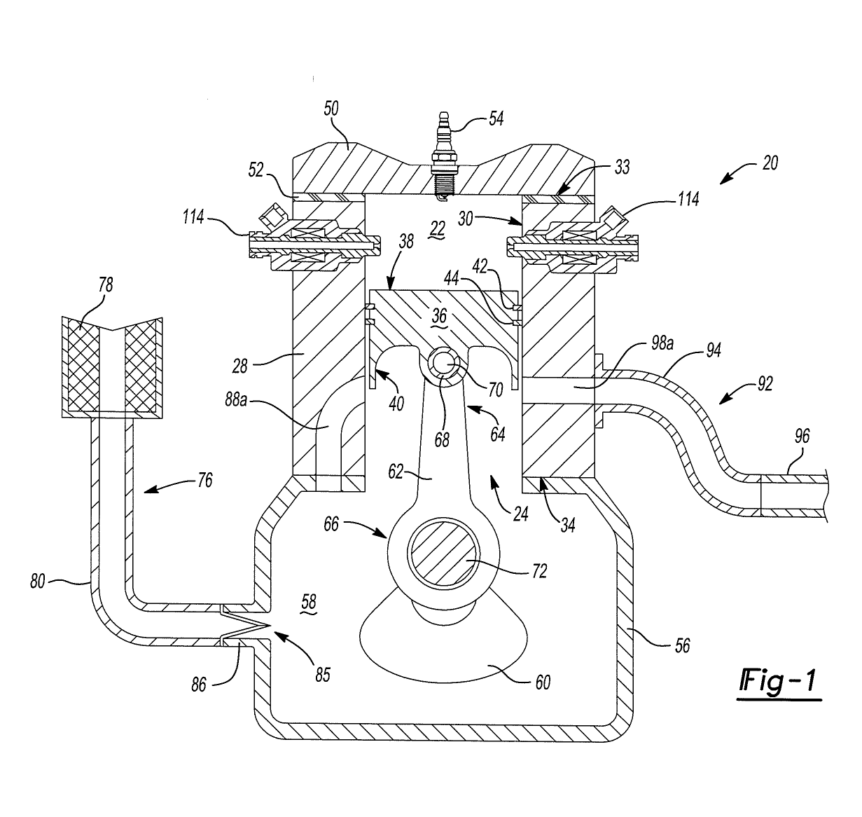

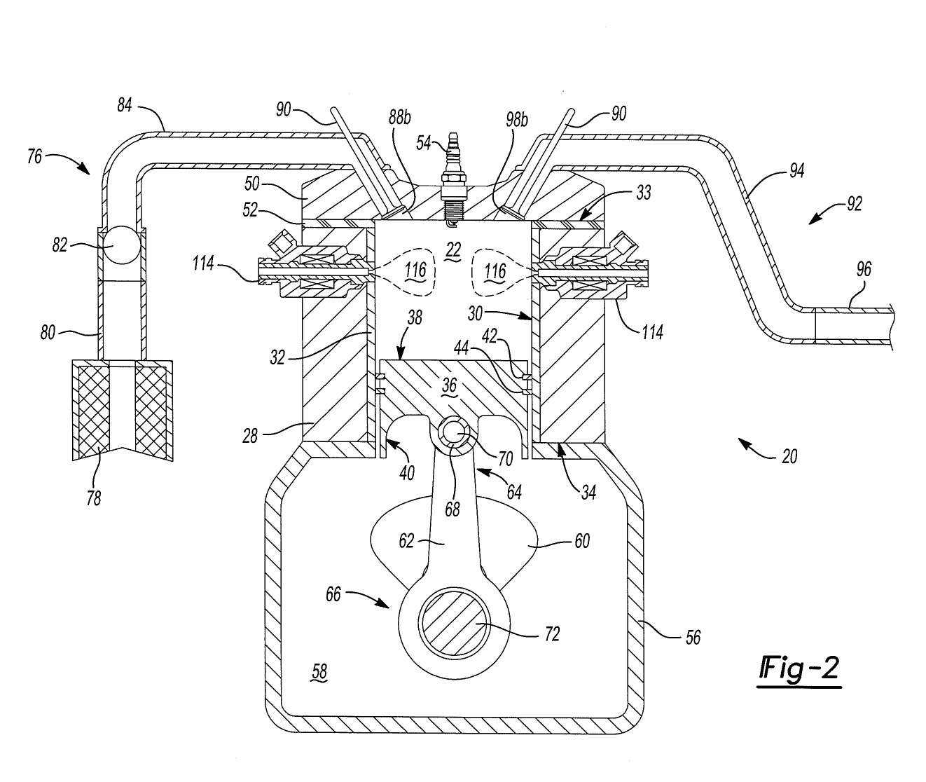

With reference to FIGS. 1 and 2, the disclosed piston engine apparatus 20 with non-circular combustion chambers 22 includes a cylinder block 28 having a cylinder wall 30 that defines one or more cylinder bores 24. The cylinder block 28 may be made of a variety of different materials, including without limitation, cast iron, steel, aluminum, and alloys thereof. The cylinder wall 30 may be defined by the cylinder block 28 itself as shown in FIG. 1 or a sleeve 32 disposed within the cylinder block 28 as shown in FIG. 2. When present, the sleeve 32 may be made of the same material as the cylinder block 28 or a different material from the cylinder block 28. The cylinder bores 24 extend longitudinally through the cylinder block 28 and are open at opposing faces 33, 34 of the cylinder block 28. With reference to FIG. 5, each of the cylinder bores 24 has a cylinder bore axis A co-axially aligned within the cylinder bore 24. Accordingly, the cylinder bore axis A of each of the cylinder bores 24 extends in the longitudinal direction.

The cylinder block 28 may have multiple banks 26 with a plurality of cylinder bores 24 defined within each one of the multiple banks 26 of the cylinder block 28. As shown in FIG. 5, the multiple cylinder bores 24 disposed within bank 26 of the cylinder block 28 have cylinder bore axes A that are parallel and evenly spaced with respect to one another. The multiple banks 26 of the cylinder block 28 may also be disposed at an angle with respect to one another. Stated another way, the cylinder bore axes A of the cylinder bores 24 disposed within one bank 26 of the cylinder block 28 may be oriented at an angle with respect to the cylinder bore axes A of the cylinder bores 24 disposed within another bank of the cylinder block 28. Where this angle is equal to approximately one hundred and eighty degrees (180°), the cylinder block 28 may be said to have a horizontally opposed cylinder arrangement. Where this angle is less than approximately one hundred and eighty degrees (180°), the cylinder block 28 may be said to have a V-type cylinder arrangement. Without limitation, such V-type cylinder arrangements are commonly referred to as V4, V6, V8, V10, and V12 engines depending on the number of cylinder bores 24 contained within the cylinder block 28.

Referring again to FIGS. 1 and 2, a piston 36 is slidingly disposed in the cylinder bore 24. During operation of the piston engine 20, the piston 36 reciprocates longitudinally within the cylinder bore 24 along the cylinder bore axis A. As the piston 36 reciprocates within the cylinder bore 24, the piston 36 moves between a top dead center position as shown in FIG. 1 and a bottom dead center position as shown in FIG. 2. It should be appreciated that the top dead center position and the bottom dead center position delineate the range of travel of the piston 36 within the cylinder bore 24. The piston 36 may be made of a variety of different materials, including without limitation, cast iron, steel, aluminum, and alloys thereof. As seen in FIGS. 1, 2, and 4, the piston 36 includes a crown portion 38 that extends across the cylinder bore 24 and a skirt portion 40 that extends longitudinally with respect to the cylinder bore 24. Accordingly, the crown portion 38 of the piston 36 is disposed in a generally transverse relationship with respect to the cylinder wall 30 and the cylinder bore axis A and is acted on by gas pressures in the cylinder bore 24 produced as a result of the internal combustion process. The skirt portion 40 of the piston 36 extends from the crown portion 38 in a direction that is substantially parallel with the cylinder wall 30 and the cylinder bore axis A. It should be understood that the term “substantially parallel” as used herein means the angle between components or axes is less than ten degrees (10°). Accordingly, the skirt portion 40 of the piston 36 prevents excessive rocking of the piston 36 as the piston 36 reciprocates within the cylinder bore 24. The crown portion 38 and the skirt portion 40 of the piston 36 may be integral with one another such that the piston 36 is one continuous piece or, alternatively, the crown portion 38 and the skirt portion 40 of the piston 36 may be separate pieces that are connected to one another to form the piston 36.

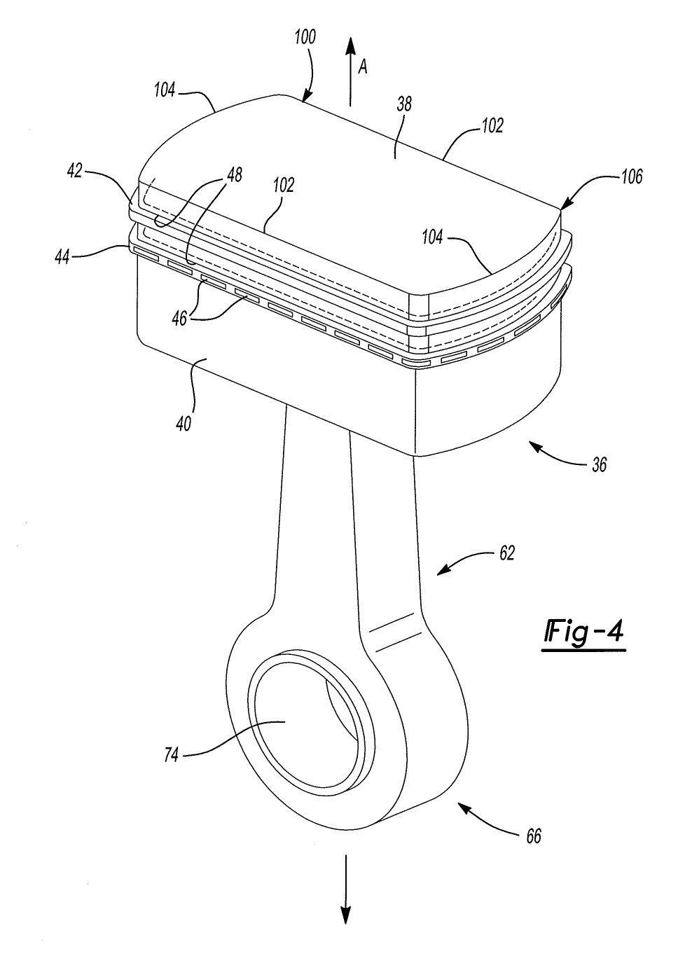

Still referring to FIG. 4, the piston 36 may optionally carry one or more of: a piston ring 42 and/or an oil ring 44. When present, the piston ring 42 is disposed about the piston 36 at a location that is longitudinally adjacent the crown portion 38 of the piston 36. The piston ring 42 contacts both the piston 36 and the cylinder wall 30 to seal the piston 36 against the cylinder wall 30 of the cylinder block 28. As such, the piston ring 42 helps to prevent blow-by of combustion gases generated in connection with the internal combustion process, a condition where combustion gases pass through a narrow gap between the piston 36 and the cylinder wall 30. The oil ring 44 is disposed about the piston 36 at a location that is positioned longitudinally between the piston ring 42 and the skirt portion 40 of the piston 36. Although different types of oil rings 44 are available, the oil ring 44 may generally define a plurality of orifices 46 that communicate oil contained within the cylinder bore 24 to the cylinder wall 30 to lubricate the cylinder wall 30. It should be appreciated that the piston 36, piston ring 42, and/or the oil ring 44 can cause significant friction and wear as a result of contact with the cylinder wall 30. Accordingly, it is beneficial to keep the cylinder wall 30 well lubricated during operation of the piston engine 20. While piston rings 42 and oil rings 44 come in a variety of different forms, the piston ring 42 and oil ring 44 may be, by way of example and without limitation, non-circular in cross-section such that the piston ring 42 and the oil ring 44 generally follow the shape of the piston 36. By way of non-limiting example, the piston ring 42 and the oil ring 44 may be made of cast iron, steel, or an alloy thereof. Generally, the piston ring 42 and the oil ring 44 are received by respective slots 48 extending about the piston 36 such that the piston ring 42 and the oil ring 44 are restricted from sliding longitudinally with respect to the piston 36.

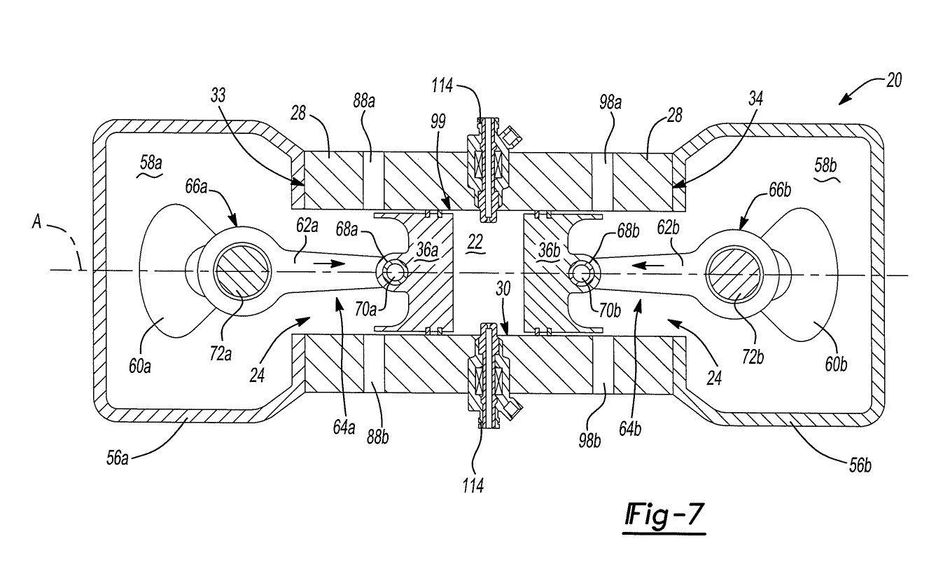

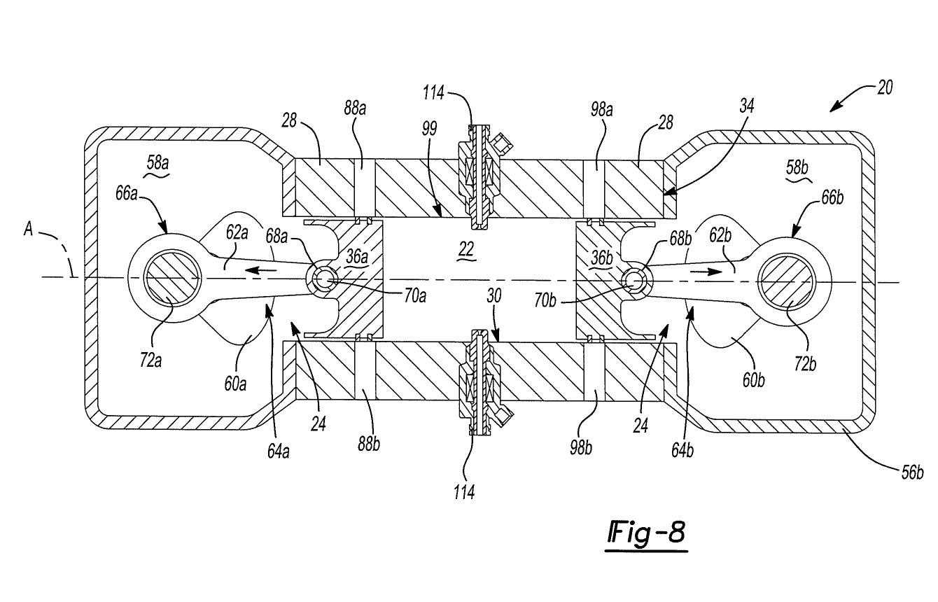

With reference to FIGS. 1 and 2, a cylinder head 50 is disposed in sealing engagement with the cylinder block 28. The cylinder head 50 generally abuts one of the opposing faces 33 of the cylinder block 28 to define the combustion chamber 22 within the cylinder bore 24 between the cylinder head 50 and the crown portion 38 of the piston 36. As shown in FIG. 2, a sealing gasket 52 may be provided between the cylinder head 50 and the cylinder block 28 to prevent combustion gasses from escaping the combustion chamber 22. It should also be appreciated that other engine configurations are possible that lack cylinder heads altogether. Such engine configurations, including opposed-piston engines (FIGS. 7 and 8) are still considered to be within the scope of the present disclosure.

A spark plug 54 may extend through the cylinder head 50 and into the combustion chamber 22. The spark plug 54 selectively applies an electrical spark to the combustion chamber 22 during operation of the piston engine 20 to ignite an air/fuel mixture contained therein. It should be appreciated that the terms “spark plug” and “glow plug” as used herein are interchangeable and it is understood that spark plugs 54 are used in spark-ignition engines and glow plugs may be used in compression-ignition engines. It should also be understood that such compression-ignition engines may be provided without glow plugs without departing from the scope of the present disclosure.

A crankcase 56 is also disposed in sealing engagement with the cylinder block 28. The crankcase 56 generally abuts the cylinder block 28 opposite the cylinder head 50. In other words, one of the opposing faces 33 of the cylinder block 28 mates with the cylinder head 50 while the other one of the opposing faces 34 of the cylinder block 28 mates with the crankcase 56. The crankcase 56 defines a crankcase cavity 58 therein that receives a crankshaft 60. The crankshaft 60 of the piston engine 20 is rotatably supported in the crankcase cavity 58 and extends laterally with respect to the cylinder bore 24. As such, the crankcase 56 is oriented in a transverse relationship with respect to the cylinder bore axis A. A connecting rod 62 extends between the piston 36 and the crankshaft 60 to rotatably connect the piston 36 to the crankshaft 60. More particularly, the connecting rod 62 has a small end 64 that is pivotally connected to the piston 36 and big end 66 that is pivotally connected to the crankshaft 60. A wrist pin 68 of cylindrical shape is connected to the piston 36 and the small end 64 of the connecting rod 62 defines a wrist pin bore 70 that receives the wrist pin 68 such that the connecting rod 62 pivots about the wrist pin 68. As shown in FIGS. 1, 2, and 5, the crankshaft 60 has a crankshaft lobe 72 of cylindrical shape that is off-set with respect to a central axis C of the crankshaft 60. The big end 66 of the connecting rod 62 defines a crank pin bore 74 (FIG. 4) that receives the crankshaft lobe 72 such that the crankshaft 60 can rotate with respect to the connecting rod 62. Accordingly, the connecting rod 62 translates reciprocal motion of the piston 36 to rotational motion of the crankshaft 60 during operation of the piston engine 20.

Referring again to FIGS. 1 and 2, the piston engine 20 generally includes an intake tract 76 that receives air from the environment during operation of the piston engine 20. The intake tract 76 may include one or more components, including for example, a filter 78, an intake tube 80, a throttle body 82, and an intake manifold 84. As shown in FIG. 1, where the piston engine 20 is a direct-injected two-stroke engine, the crankcase 56 may define an intake passage 85 in fluid communication with the intake tract 76 that extends through the crankcase 56. During operation of the piston engine 20, an air induction charge flows through the intake passage 85 and into the crankcase cavity 58. The intake passage 85 may include a reed block 86. The reed block 86 acts as a one way valve that allows air to be drawn into the crankcase cavity 58 and prevents air from exiting through the intake passage 85. As shown in FIG. 1, where the piston engine 20 is a direct-injected two-stroke engine, an intake port 88a is defined by and extends through the cylinder block 28. The intake port 88a is thus open to the cylinder bore 24 and supplies air to the combustion chamber 22. The intake port 88a extends through the cylinder wall 30 and receives air directly from the crankcase cavity 58. In this configuration, the intake port 88a may also be referred to as a transfer port 88a. As shown in FIG. 2, where the piston engine 20 is a direct-injected four-stroke engine, an intake port 88b is defined by and extends through the cylinder head 50. The intake port 88b receives air directly from the intake tract 76 and may include a poppet valve 90 to control the opening and closing of the intake port 88b. It should also be appreciated that the intake configurations illustrated in FIGS. 1 and 2 and described herein are merely exemplary and that other intake configurations are possible for both two-stroke engines and four-stroke engines.

The piston engine 20 also generally includes an exhaust tract 92 that receives exhaust from the combustion chamber 22 during operation of the piston engine 20. The exhaust tract 92 may include one or more components, including for example, an exhaust manifold 94 and an exhaust pipe 96. As shown in FIG. 1, where the piston engine 20 is a direct-injected two-stroke engine, an exhaust port 98a disposed in fluid communication with the combustion chamber 22 and the exhaust tract 92 is defined by and extends through the cylinder block 28 and the cylinder wall 30. Accordingly, the exhaust port 98a is open to the cylinder bore 24 to scavenge exhaust from the combustion chamber 22. As shown in FIG. 2, where the piston engine 20 is a direct-injected four-stroke engine, an exhaust port 98b disposed in fluid communication with the combustion chamber 22 and the exhaust tract 92 is defined by and extends through the cylinder head 50. The exhaust port 98b may include a poppet valve 90 to control the opening and closing of the exhaust port 98b.

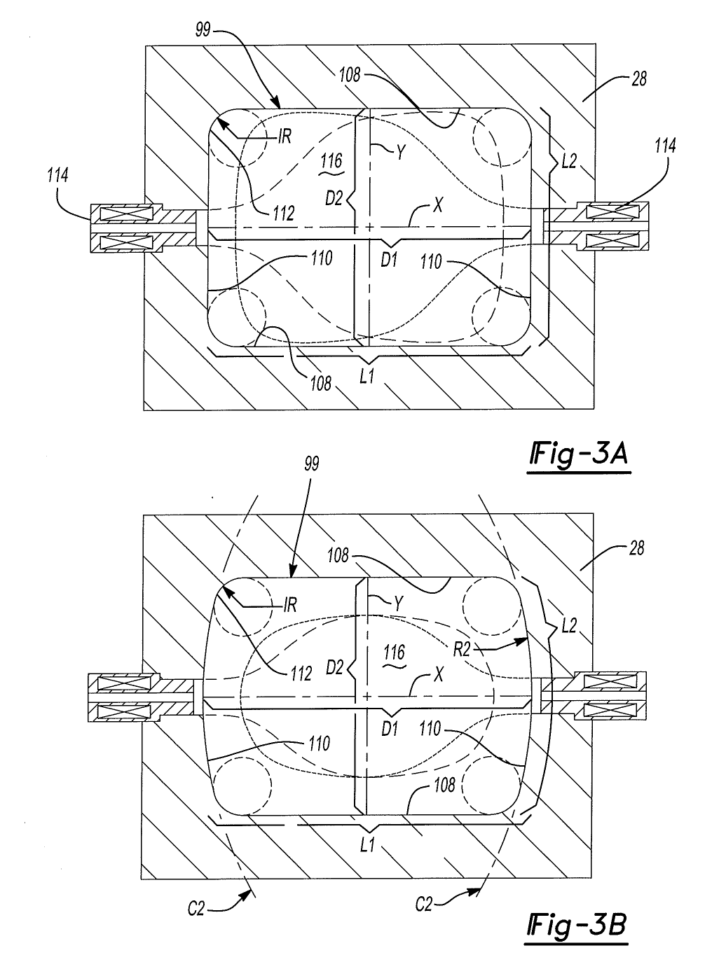

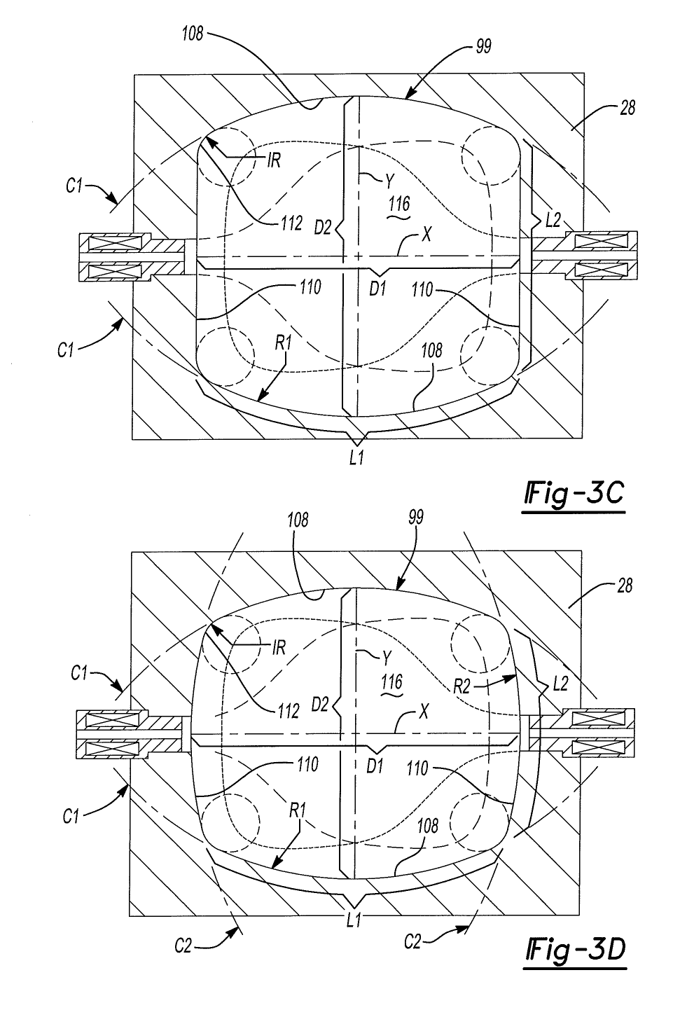

Referring generally to FIGS. 3A-3D and FIGS. 4 and 6, the cylinder bore 24, the piston 36, and the combustion chamber 22 each have a non-circular cross-section 99 that is transverse to the cylinder bore axis A. In other words, the non-circular cross section 99 is best appreciated when the piston 36, the cylinder bore 24, and the combustion chamber 22 are viewed from a point disposed along the cylinder bore axis A. The non-circular cross section 99 may have a generally rectangular shape (e.g. FIG. 3A), a generally oval shape, or another non-circular shape. The crown portion 38 of the piston 36 has a periphery 100 defined by the outer most portions of the crown portion 38. The periphery 100 of the crown portion 38 of the piston 36 includes a first pair of sides 102 that oppose one another and a second pair of sides 104 that oppose one another. The second pair of sides 104 extend between the first pair of sides 102 so as to complete the periphery 100 of the crown portion 38 of the piston 36. The first pair of sides 102 and the second pair of sides 104 are joined by rounded corners 106. In other words, the first pair of slides 102 and the second pair of sides 104 of the piston 36 converge and meet at the rounded corners 106 of the piston 36. The rounded corners 106 have a different curvature relative to a curvature of the first pair of sides 102 and the second pair of sides 104.

The cylinder wall 30 has a plurality of faces 108, 110 that slidingly engage the periphery 100 of the crown portion 38 of the piston 36. The plurality of faces 108, 110 of the cylinder wall 30 include a first pair of faces 108 that oppose one another and a second pair of faces 110 that oppose one another. The second pair of faces 110 extend between the first pair of faces 108 so as to define the non-circular cross-section 99 of the cylinder bore 24 and thus the combustion chamber 22. The first pair of faces 108 and the second pair of faces 110 of the cylinder wall 30 are joined by rounded intersections 112. In other words, the first paid of faces 108 and the second pair of faces 110 of the cylinder wall 30 converge and meet at the rounded intersections 112. The rounded intersections 112 have a different curvature relative to a curvature of the first pair of faces 108 and the second pair of faces 110. It should be appreciated that when the piston 36 is disposed in the cylinder bore 24, the first pair of sides 102 of the crown portion 38 of the piston 36 match the first pair of faces 108 of the cylinder wall 30, the second pair of sides 104 of the crown portion 38 of the piston 36 match the second pair of faces 110 of the cylinder wall 30, and the rounded corners 106 of the crown portion 38 of the piston 36 match the rounded intersections 112 of the cylinder wall 30.

Several variations in the shape of the combustion chamber 22 are possible without departing from the scope of the present disclosure. For example and without limitation, the first pair of faces 108 of the cylinder wall 30 may be flat and parallel to one another as shown in FIGS. 3A and 3B. Alternatively, the first pair of faces 108 of the cylinder wall 30 may be curved such that they bow outwardly with respect to the cylinder bore axis A as shown in FIGS. 3C and 3D. Similarly, the second pair of faces 110 of the cylinder wall 30 may be flat and parallel to one another as shown in FIGS. 3A and 3C. Alternatively, the second pair of faces 110 may be curved and bow outwardly with respect to the cylinder bore axis A as shown in FIGS. 3B and 3D. Accordingly, several combinations of flat and curved faces of the cylinder wall 30 exist. It should also be appreciated that because the crown portion 38 of the piston 36 follows the configuration and shape of the cylinder wall 30, the first pair of sides 102 and the second pair of sides 104 of the crown portion 38 of the piston 36 exhibit these same shapes and combinations.

The curvature of the rounded intersections 112 may be defined by an intersection radius IR. Because the rounded corners 106 of the crown portion 38 of the piston 36 match the rounded intersections 112 of the cylinder wall 30, the curvature of the rounded corners 106 of the piston 36 may also be defined by the intersection radius IR. In FIGS. 3A-3D, four rounded intersections 112 are shown, each having the same intersection radius IR. Where the first pair of faces 108 bow outwardly with respect to the cylinder bore 24 (FIGS. 3C and 3D), the first pair of faces 108 follow a first curve C1 that has a first radius R1. The first radius R1 of the first pair of faces 108 is larger than the intersection radius IR of the rounded intersections 112. Where the second pair of faces 110 bow outwardly with respect to the cylinder bore 24 (FIGS. 3B and 3D), the second pair of faces 110 follow a second curve C2 that has a second radius R2. The second radius R2 of the second pair of faces 110 is also larger than the intersection radius IR of the rounded intersections 112. Further, the second radius R2 of the second pair of faces 110 may be larger, smaller, or the same size as the first radius R1 of the first pair of faces 108. The same applies to the first pair of sides 102, second pair of sides 104, and the rounded corners 106 of the periphery 100 of the crown portion 38 of the piston 36 since the periphery 100 matches the shape and closely follows the dimensions of the cylinder wall 30 (subject to minor variations to establish clearance between the piston 36 and the cylinder wall 30).

Notwithstanding, where the faces 108, 110 of the cylinder wall 30 are curved, the curve itself may have many forms that may or may not follow a perfect semi-circle. Further, the rounded intersections 112 of the cylinder wall 30 and the rounded corners 106 of the crown portion 38 of the piston 36 may or may not follow a perfect semi-circle. The non-circular cross-section 99 is bisected by a first centerline X in one direction and a second centerline Y in another direction. In other words, the first centerline X is transverse to the second centerline Y such that the first centerline X intersects the second centerline Y at a 90 degree angle. The first centerline X may extend along a first distance D1 that spans the cylinder bore 24 in one direction and the second centerline Y may extend along a second distance D2 that spans the cylinder bore 24 in another direction. In some configurations, including those shown in FIGS. 3A-3D, the non-circular cross-section 99 of the cylinder bore 24, the piston 36, and the combustion chamber 22 is elongated in one direction. Where the non-circular cross-section 99 is elongated, the first distance D1 of the first centerline X is larger than the second distance D2 of the second centerline Y. Further, the first pair of faces 108 of the cylinder wall 30 may extend along a first length L1 and the second pair of faces 110 of the cylinder wall 30 may extend along a second length L2, where the first length L1 is larger than the second length L2. Accordingly, the first pair of faces 108 may be elongated relative to the second pair of faces 110. The same applies to the first pair of sides 102, the second pair of sides 104, and the rounded corners 106 of the periphery 100 of the crown portion 38 of the piston 36 since the periphery 100 matches the shape and closely follows the dimensions of the cylinder wall 30 (subject to minor variations to establish clearance between the piston 36 and the cylinder wall 30.)

As best seen in FIGS. 1, 2, 3A-3D, and 6, a pair of opposing fuel injectors 114 are disposed in fluid communication with the combustion chamber 22. The pair of opposing fuel injectors 114 extend through the cylinder block 28 to the cylinder bore 24 such that the pair of opposing fuel injectors 114 are positioned along the first centerline X on opposite sides of the cylinder bore 24. As such, the pair of opposing fuel injectors 114 may be disposed along the second pair of faces 110 of the cylinder wall 30 with one injector per face. It should be appreciated that the pair of opposing fuel injectors 114 may protrude into the combustion chamber 22 from the cylinder wall 30 as shown in FIG. 1, may be flush with the cylinder wall 30 as shown in FIG. 2, or may be counter-sunk in the cylinder block 28 as shown in FIGS. 3A-3D.

The pair of opposing fuel injectors 114 spray converging fuel plumes 116 into the combustion chamber 22 to reduce stratification of the air/fuel mixture across the non-circular cross-section of the combustion chamber 22. In this way, the non-circular cross section of the combustion chamber 22 closely matches the shape of the converging fuel plumes 116 that are injected into the combustion chamber 22 by the pair of opposing fuel injectors 114. This creates fuel spray targeting advantages that lead to efficient mixing of the air/fuel mixture and minimizes the inaccessible volume associated with circular bore combustion chambers 22. Advantageously, more efficient combustion and improved emissions are realized. It should be understood that the term “converging fuel plumes” as used herein means that the pair of opposing fuel injectors 114 spray fuel towards one another. The converging fuel plumes 116 may or may not contact one another in the combustion chamber 22. Similarly, the converging fuel plumes 116 may or may not overlap or cross one another in the combustion chamber 22. All of these conditions may still be considered “converging fuel plumes” in accordance with the scope of the present disclosure.

With reference to FIG. 6, where multiple cylinder bores 24a, 24b are defined within a bank 26 of the cylinder block 28, the non-circular, elongated cross-sections 99a, 99b of the cylinder bores 24a, 24b may be arranged in a side-by-side spaced relationship such that the first pair of faces 108a, 108b of the cylinder walls 30a, 30b are immediately adjacent one another. For example and without limitation, the multiple cylinder bores 24a, 24b of the cylinder block 28 may include a first cylinder bore 24a and a second cylinder bore 24b each having a first pair of faces 108a, 108b, a second pair of faces 110a, 110b, a first centerline X, X′, and a second centerline Y, Y′. Due to the elongated shape of the non-circular cross-sections 99a, 99b, the first centerlines X, X′ are longer than the second centerlines Y, Y′. The first cylinder bore 24a and the second cylinder bore 24b are arranged in a side-by-side spaced relationship such that one of the first pair of faces 108a of the first cylinder bore 24a is immediately adjacent one of the first pair of faces 108b of the second cylinder bore 24b. Stated another way, the first cylinder bore 24a and the second cylinder bore 24b are arranged such that the first centerline X of the non-circular, elongated cross-section 99a of the first cylinder bore 24a is parallel to the second centerline X′ of the non-circular, elongated cross-section 99b of the second cylinder bore 24b. Accordingly, the portion of the cylinder block 118 disposed between faces 108a, 108b of adjacent cylinder bores 24a, 24b is minimized leading to a smaller cylinder block 28.

Advantageously, the foregoing arrangement of the cylinder bores 24 provides packaging benefits. Engine parameters and material limitations dictate the minimum block thickness T between adjacent cylinder bores 24 (FIG. 6). For a piston engine 20 of any given number of cylinders and displacement, this minimum block thickness T dictates an overall length OL of the cylinder block 28. In accordance with the cylinder arrangement of the subject disclosure, the overall length OL of the cylinder block 28 can be reduced while maintaining the minimum block thickness T between adjacent cylinder bores 24a, 24b because a width W of the cylinder bores 24a, 24b is less for the given displacement. It should be appreciated that the width W of the cylinder bores 24a, 24b generally corresponds to the second distance D2 of the second centerlines Y, Y′. This reduces the overall dimensions of the piston engine 20 and can lead to weight and cost savings because less material is required for the cylinder block 28.

With reference to FIGS. 7 and 8, the piston engine 20 is shown in an opposed-piston engine arrangement. Again, the cylinder block 28 may have one or more cylinder bores 24, where each cylinder bore 24 receives a piston 36a and an opposing piston 36b that are slidingly disposed therein. In accordance with the teachings of the subject disclosure, the cylinder bore 24, the piston 36a, the opposing piston 36b, and the combustion chamber 22 all have any one of the non-circular cross-sections 99 described with reference to FIGS. 3A-3D, which may optionally be elongated. The piston 36a and the opposing piston 36b generally move toward one another (FIG. 7) in a first mode of operation and away from one another (FIG. 8) in a second mode of operation. Movement of the piston 36a and the opposing piston 36b relative to and within the cylinder bore 24 drives a first crankshaft 60a and a second crankshaft 60b. The first crankshaft 60a and the second crankshaft 60b are supported by a first crankcase 56a and a second crankcase 56b, respectively. The first crankcase 56a and the second crankcase 56b are disposed on opposite ends of the cylinder block 28, where the first crankcase 56a abuts face 33 of the cylinder block 28 and the second crankcase 56b abuts face 34 of the cylinder block 28. The first crankcase 56a defines a first crankcase cavity 58a therein and the second crankcase 56b defines a second crankcase cavity 58b therein. Both the first crankcase cavity 58a and the second crankcase cavity 58b are disposed in fluid communication with the cylinder bore 24.

The first crankshaft 60a is disposed within the first crankcase cavity 58a and the second crankshaft 60b is disposed within the second crankcase cavity 58b. The first crankshaft 60a is coupled to piston 36a by a first connecting rod 62a. The first crankshaft 60a rotates about an axis of rotation that is transverse to the cylinder bore axis A. The small end 64a of the first connecting rod 62a is pivotally connected to the piston 36a at the wrist pin 68a of the piston 36a. The big end 66a of the first connecting rod 62a is pivotally connected to the first crankshaft 60a at the crankshaft lobe 72a of the first crankshaft 60a. Specifically, the wrist pin bore 70a in the piston 36a and the small end 64a of the first connecting rod 62a each receive the wrist pin 68a to establish a pivoting connection between the piston 36a and the first connecting rod 62a. Similarly, the crank pin bore 74a in the big end 66a of the first connecting rod 62a receives the crankshaft lobe 72a of the first crankshaft 60a to establish a pivoting connection between the first connecting rod 62a and the first crankshaft 60a. Accordingly, the first connecting rod 62a translates the reciprocal motion of the piston 36a into rotational motion of the first crankshaft 60a. The second crankshaft 60b is coupled to opposing piston 36b by a second connecting rod 62b. The second crankshaft 60b rotates about an axis of rotation that is transverse to the cylinder bore axis A. The axis of rotation of the second crankshaft 60b is generally parallel to and spaced from the axis of rotation of the first crankshaft 60a. Accordingly, the cylinder block 28 is positioned between the first crankshaft 60a and the second crankshaft 60b. The small end 64b of the second connecting rod 62b is pivotally connected to the opposing piston 36b at the wrist pin 68b of the opposing piston 36b. The big end 66b of the second connecting rod 62b is pivotally connected to the second crankshaft 60b at the crankshaft lobe 72b of the second crankshaft 60b. Specifically, the wrist pin bore 70b in the opposing piston 36b and the small end 64b of the second connecting rod 62b each receive the wrist pin 68b to establish a pivoting connection between the opposing piston 36b and the second connecting rod 62b. Similarly, the crank pin bore 74b in the big end 66b of the second connecting rod 62b receives the crankshaft lobe 72b of the second crankshaft 60b to establish a pivoting connection between the second connecting rod 62b and the second crankshaft 60b. Accordingly, the second connecting rod 62b translates the reciprocal motion of the opposing piston 36b into rotational motion of the second crankshaft 60b.

Still referring to FIGS. 7 and 8, the combustion chamber 22 in the opposed-piston engine 20 is disposed within the cylinder bore 24 between the piston 36a and the opposing piston 36b. Thus, the pair of opposing fuel injectors 114 may be disposed along and extend through the cylinder wall 30 such that the pair of opposing fuel injectors 114 can inject fuel directly into the combustion chamber 22. Thus, the pair of opposing fuel injectors 114 may be operated to spray fuel directly into the combustion chamber 22 during the first mode of operation. Where the opposed-piston engine 20 is a compression ignition engine, the fuel injected into the combustion chamber 22 is compressed and ignites as the piston 36a and the opposing piston 36b approach one another. Alternatively, where the opposed-piston engine 20 is a spark ignition engine, a spark plug (not shown) may extend through the cylinder block 28 into the combustion chamber 22. The spark plug may be operated to supply a spark to the combustion chamber 22 to initiate combustion therein. The cylinder block 28 may include multiple intake ports 88a, 88b and multiple exhaust ports 98a, 98b that are longitudinally spaced from one another. The intake ports 88a, 88b and the exhaust ports 98a, 98b extend through the cylinder wall 30 and are arranged in fluid communication with the cylinder bore 24. As shown in FIGS. 7 and 8, the piston 36a may operate to open and closed the intake ports 88a, 88b while the opposing piston 36b may operate to open and close the exhaust ports 98a, 98b as the piston 36a and the opposing piston 36b reciprocate within the cylinder bore 24.

As noted above, the piston 36a and the opposing piston 36b move toward one another in the first mode of operation and away from one another in the second mode of operation. The first and second modes of operation occur sequentially during a single engine cycle as the piston 36a and the opposing piston 36b translate between a top dead-center position (shown in FIG. 7) and a bottom dead-center position (shown in FIG. 8). Where the opposed-piston engine 20 is a two-stroke engine, the first mode of operation and the second mode of operation comprise the entirety of the single engine cycle. An intake charge of air or an air/fuel mixture is supplied to the combustion chamber 22 through the intake ports 88a, 88b. The intake charge is compressed by the piston 36a and the opposing piston 36b during the first mode of operation. This compression may cause the intake charge to ignite when the piston 36a and the opposing piston 36b are at or near the top dead-center position, as shown in FIG. 7. The resulting combustion of the intake charge drives the piston 36a and the opposing piston 36b apart during the second mode of operation. Alternatively, spark ignition may be used to control ignition of the intake charge during the first mode of operation. Regardless, combustion of the intake charge produces high pressures within the combustion chamber 22 and exhaust gasses. As the piston 36a and the opposing piston 36b are driven apart during the second mode of operation, the piston 36a and the opposing piston 36b pass by the intake ports 88a, 88b and the exhaust ports 98a, 98b as the piston 36a and the opposing piston 36b move to the bottom dead-center position. In accordance with the outward movement of the piston 36a and the opposing piston 36b, the intake ports 88a, 88b and the exhaust ports 98a, 98b are opened and become exposed to the combustion chamber 22. The exhaust gases thus exit the combustion chamber 22 through the exhaust ports 98a, 98b and a new intake charge enters the combustion chamber 22 through the intake ports 88a, 88b such that the engine cycle may begin anew.

Alternatively, where the opposed-piston engine 20 is a four-stroke engine, the single engine cycle may include two of the first modes of operation and two of the second modes of operation. The single engine cycle may begin with the second mode of operation where the intake charge enters the cylinder bore 24 as the piston 36a and the opposing piston 36b move apart. The intake charge is then compressed in the first mode of operation where the piston 36a and the opposing piston 36b approach one another. The intake charge ignites and the combustion forces the piston 36a and the opposing piston 36b apart in another second mode of operation. Next, the piston 36a and the opposing piston 36b move in another first mode of operation where the piston 36a and the opposing piston 36b again approach one another to expel exhaust gases out of the cylinder bore 24.

Obviously, many modifications and variations of the present invention are possible in light of the above teachings and may be practiced otherwise than as specifically described while within the scope of the appended claims. These antecedent recitations should be interpreted to cover any combination in which the inventive novelty exercises its utility.

What is claimed is:

1. A piston engine comprising:
a cylinder block including a cylinder wall defining at least one cylinder bore, said at least one cylinder bore having cylinder bore axis;
a piston slidingly disposed in said at least one cylinder bore;
a combustion chamber at least partially defined within said at least one cylinder bore by said piston and said cylinder wall;
said at least one cylinder bore, said piston, and said combustion chamber each having a non-circular cross-section that is transverse to said cylinder bore axis; and
said cylinder wall including a first pair of faces that oppose one another and a second pair of faces that oppose one another, said second pair of faces extending between said first pair of faces, and said first pair of faces and said second pair of faces converging at rounded intersections having a different curvature relative to said first pair of faces and said second pair of faces.

2. The piston engine as set forth in claim 1 wherein said first pair of faces have zero curvature such that said first pair of faces are flat and parallel to one another and wherein said second pair of faces have zero curvature such that said second pair of faces are flat and parallel to one another.

3. The piston engine as set forth in claim 1 wherein said rounded intersections each have an intersection radius.

4. The piston engine as set forth in claim 3 wherein said first pair of faces bow outwardly with respect to said at least one cylinder bore along a curve having a radius that is greater than said intersection radius and wherein said second pair of faces have zero curvature such that said second pair of faces are flat and parallel to one another.

5. The piston engine as set forth in claim 3 wherein said first pair of faces bow outwardly with respect to said at least one cylinder bore along a first curve having a first radius that is greater than said intersection radius and wherein said second pair of faces bow outwardly with respect to said at least one cylinder bore along a second curve having a second radius that is greater than said intersection radius.

6. The piston engine as set forth in claim 5 wherein said first radius of said first pair of faces is the same as said second radius of said second pair of faces.

7. The piston engine as set forth in claim 5 wherein said first radius of said first pair of faces is different than said second radius of said second pair of faces.

8. The piston engine as set forth in claim 1 further comprising:
a pair of opposing fuel injectors in fluid communication with said combustion chamber that extend through said cylinder block to said at least one cylinder bore, said pair of opposing fuel injectors being positioned along one of said first pair faces and said second pair of faces such that said pair of opposing fuel injectors spray converging fuel plumes into said combustion chamber during operation of the piston engine to reduce air/fuel stratification.

9. The piston engine as set forth in claim 8 wherein said piston has a periphery that abuts said first pair of faces and said second pair of faces of said cylinder wall in sliding engagement.

10. The piston engine as set forth in claim 1 further comprising:
a cylinder head disposed in sealing engagement with said cylinder block such that said combustion chamber is positioned in said at least one cylinder bore between said piston and said cylinder head.

11. The piston engine as set forth in claim 1 wherein the piston engine is an opposed-piston engine and includes an opposing piston disposed in said at least one cylinder bore such that both said piston and said opposing piston are slidingly disposed in said at least one cylinder bore, wherein said piston and said opposing piston move toward one another in a first mode of operation and away from one another in a second mode of operation, and wherein said combustion chamber is positioned in said at least one cylinder bore between said piston and said opposing piston.

12. A cylinder block comprising:
a cylinder wall defining at least one cylinder bore, said at least one cylinder bore having cylinder bore axis;
said at least one cylinder bore having a non-circular, elongated cross-section that is transverse to said cylinder bore axis; and
said cylinder wall including a first pair of faces that oppose one another and a second pair of faces that oppose one another, said first pair of faces extending along a first length, said second pair of faces extending between said first pair of faces along a second length that is smaller than said first length, and said first pair of faces and said second pair of faces converging at rounded intersections having a different curvature relative to said first pair of faces and said second pair of faces.

13. The cylinder block as set forth in claim 12 wherein said first pair of faces have zero curvature such that said first pair of faces are flat and parallel to one another and wherein said second pair of faces have zero curvature such that said second pair of faces are flat and parallel to one another.

14. The cylinder block as set forth in claim 12 wherein said rounded intersections each have an intersection radius.

15. The cylinder block as set forth in claim 14 wherein said first pair of faces bow outwardly with respect to said at least one cylinder bore along a curve having a radius that is greater than said intersection radius and wherein said second pair of faces have zero curvature such that said second pair of faces are flat and parallel to one another.

16. The cylinder block as set forth in claim 14 wherein said first pair of faces have zero curvature such that said first pair of faces are flat and parallel to one another and wherein said second pair of faces bow outwardly with respect to said at least one cylinder bore along a curve having a radius that is greater than said intersection radius.

17. The cylinder block as set forth in claim 14 wherein said first pair of faces bow outwardly with respect to said at least one cylinder bore along a first curve having a first radius that is greater than said intersection radius and wherein said second pair of faces bow outwardly with respect to said at least one cylinder bore along a second curve having a second radius that is greater than said intersection radius.

18. The cylinder block as set forth in claim 12 further comprising:
a pair of opposing fuel injectors in fluid communication with said combustion chamber that extend through said cylinder block to said at least one cylinder bore, said pair of opposing fuel injectors being positioned along said second pair of faces such that said pair of opposing fuel injectors spray converging fuel plumes across said non-circular, elongated cross-section of said combustion chamber to reduce air/fuel stratification during operation of the piston engine.

19. The cylinder block as set forth in claim 12 wherein said at least one cylinder bore of said cylinder block includes a first cylinder bore and a second cylinder bore each having said first pair of faces and said second pair of faces, said first cylinder bore and said second cylinder bore being arranged in a side-by-side spaced relationship such that one of said first pair of faces of said first cylinder bore is disposed immediately adjacent one of said first pair of faces of said second cylinder bore.

20. The cylinder block as set forth in claim 12 wherein said at least one cylinder bore extends between and is open at two opposing faces of said cylinder block such that said at least one cylinder bore is configured to slidingly receive a piston and an opposing piston that move toward one another in a first mode of operation and away from one another in a second mode of operation.

21. A piston comprising:
a crown portion;
a skirt portion that extends longitudinally from said crown portion; and
said crown portion of said piston having a periphery including a first pair of sides that oppose one another and a second pair sides that oppose one another, said first pair of sides extending between said second pair of sides such that said first pair of sides and said second pair of sides meet at rounded corners having a different curvature relative to said first pair of sides and said second pair of sides.

22. The piston as set forth in claim 21 wherein said rounded corners each have an intersection radius.

23. The piston as set forth in claim 22 wherein said first pair of sides are longer than said second pair of sides.

24. The piston as set forth in claim 23 wherein said first pair of sides bow outwardly along a curve having a radius that is greater than said intersection radius and wherein said second pair of sides have zero curvature such that said second pair of sides are flat and parallel to one another.

25. The piston as set forth in claim 23 wherein said first pair of sides have zero curvature such that said first pair of sides are flat and parallel to one another and wherein said second pair of sides bow outwardly along a curve having a radius that is greater than said intersection radius.

26. The piston as set forth in claim 22 wherein said first pair of sides bow outwardly along a first curve having a first radius that is greater than said intersection radius and wherein said second pair of sides bow outwardly along a second curve having a second radius that is greater than said intersection radius.

27. The piston as set forth in claim 21 wherein said first pair of sides have zero curvature such that said first pair of sides are flat and parallel to one another and wherein said second pair of sides have zero curvature such that said second pair of sides are flat and parallel to one another.
